(19) United States
(12) Patent Application Publication
(10) Pub. No.: US 2015/0066341 A1
(43) Pub. Date: Mar. 5, 2015

(54) METHOD AND DEVICE FOR DETERMINING A DRIVING RECOMMENDATION FOR A VEHICLE AND METHOD AND DEVICE FOR PROVIDING A DRIVING RECOMMENDATION FOR A VEHICLE

(71) Applicant: Bjoern Von Holt, Diekholzen (DE)

(72) Inventor: Bjoern Von Holt, Diekholzen (DE)

(21) Appl. No.: 14/345,091

(22) PCT Filed: Jul. 18, 2012
(86) PCT No.: PCT/EP2012/064101

§ 371 Date: Oct. 20, 2014

(30) Foreign Application Priority Data
Sep. 14, 2011 (DE) 102011082678.5

(51) Int. Cl. G01C 21/34

(52) U.S. Cl. CPC G01C 21/3492
USPC 701/117

(57) ABSTRACT

A method for determining a driving recommendation for a vehicle is provided. The method is carried out while using a social media Internet platform and an Internet-capable navigation device, which is situated in the vehicle and is wirelessly connected to the social media Internet platform. The method has a step of receiving an item of traffic event information and an item of position information, which is associated with the item of traffic event information, from the social media Internet platform with the aid of the navigation device. The method also has a step of comparing the item of position information to an item of route information, which represents a route to be traveled by the vehicle, with the aid of the navigation device, to ascertain whether a position represented by the item of position information lies on the route to be traveled by the vehicle.

### FIELD OF THE INVENTION

The present invention relates to a method and a device for determining a driving recommendation for a vehicle, a method and a device for providing a driving recommendation for a vehicle, and a computer program product.

### BACKGROUND INFORMATION

Navigation devices for vehicles also process, inter alia, congestion warnings and other traffic messages with the aid of RDS functions or the like, for example. Social media platforms, such as Facebook or Twitter, have achieved wide distribution among users in a short time. Multiple automobile companies have already taken up this trend, to tie customers to them by providing fan portals on such social media platforms. These fan pages are used to a great extent for communication between the fans, for example. The fan pages also allow the posting of threads of the fans or customers.

German Patent No. 11 2009 000 070 discloses systems and methods for providing navigation assistance while using a social online network.

### SUMMARY

Against this background, the present invention provides a method for determining a driving recommendation for a vehicle, a method for providing a driving recommendation for a vehicle, furthermore devices for carrying out the method, and finally a corresponding computer program product.

The present invention provides a method for determining a driving recommendation for a vehicle, the method being carried out while using a social media Internet platform and an Internet-capable navigation device, which is situated in the vehicle and is wirelessly connected to the social media Internet platform, the method having the following steps:

receiving an item of traffic event information and an item of position information, which is associated with the item of traffic event information, from the social media Internet platform with the aid of the navigation device;
comparing the item of position information to an item of route information, which represents a route to be traveled by the vehicle, with the aid of the navigation device, to ascertain whether a position represented by the item of position information lies on a route to be traveled by the vehicle; and
analyzing the item of traffic event information, if the position represented by the item of position information lies on a route to be traveled by the vehicle, to determine the driving recommendation for the vehicle based on the item of traffic event information.

A vehicle may be understood in this case as a motor vehicle, in particular a road vehicle, for example, a passenger automobile, a truck, or another utility vehicle. The navigation device allows, with the aid of position determination and stored items of geo-information, route guidance to a selected location via a route while observing desired criteria and specifications. The route which may be prepared with the aid of the navigation device is represented by the route information. In addition to this navigation function, the navigation device may offer a communication function. Alternatively, the navigation device may also be connected via an interface to a communication unit, which offers the communication function. The communication function allows the navigation device to be connected to the Internet via a wireless connection. In particular, the navigation device may be a navigation device which is fixedly installed in a vehicle or a mobile navigation device which is situated in the vehicle so it is removable, for example an Internet-capable mobile telephone having a navigation function. The social media Internet platform is an Internet-based service from the field of social media. Such a social media Internet platform allows publication, exchange, and processing of digital content or items of information by the individual users of the social media Internet platform or jointly by multiple users of the social media Internet platform. For this purpose, the navigation device or the communication unit, which is associated with the navigation device, may be designed to provide an access to the social media Internet platform. The item of traffic event information may represent a traffic event, for example information about the traffic flow or the like. The item of traffic event information may be received in the form of a signal by the navigation device or the communication unit associated with the navigation device and input by the navigation device. The item of position information represents a geographical position, which is associated with the traffic event or the item of traffic event information. In particular, the item of position information may represent coordinates interpretable by the navigation device. The item of position information may be received in the form of a signal by the navigation device or the communication unit associated with the navigation device and input by the navigation device. A timestamp may also be associated with the item of traffic event information. Therefore, the type, the location, and optionally the time of a traffic event may be derived from the item of traffic event information, the item of position information, and optionally the timestamp. The step of comparing may be a mathematical and/or logical linkage of signals, for example, while using basic arithmetics, a use of a reference table, a statistical analysis, etc. In the step of comparing, a definable tolerance range for a deviation of the position represented by the item of position information from the route to be traveled by the vehicle may also be taken into consideration. During the step of analyzing, the driving recommendation is inferred from the item of traffic event information with the aid of suitable algorithms or units and according to predefined rules. The item of traffic event information may be combined preset and/or dynamically with the item of route information depending on the represented traffic event, to determine the driving recommendation. The traffic event, which is represented by the item of traffic event information, may therefore be taken into consideration in the driving recommendation. The step of analyzing may be bypassed or omitted, if the position represented by the item of position information does not lie on a route to be traveled by the vehicle.

Furthermore, the present invention creates a method for providing a driving recommendation for a vehicle, the method being carried out while using a social media Internet platform and an Internet-capable navigation device, which is situated in a vehicle and is wirelessly connected to the social media Internet platform, the method having the following steps:

inputting an item of traffic event information based on a user input with the aid of the navigation device; and
transmitting the item of traffic event information and an item of position information, which is associated with the item of traffic event information and which represents a position of the vehicle at a point in time of the input of the item of traffic event information, with the aid of the navigation device to the social media Internet platform to provide the driving recommendation.

The user input may cause a user input signal by a user interface associated with the navigation device. The user interface may be a touch screen, a keypad, and/or the like. Based on the user input signal or the user input, the item of traffic event information may be generated in the step of inputting with the aid of suitable algorithms or units, reference tables, etc., and according to predefined rules. In the step of inputting or in the step of transmitting, the item of traffic event information may be provided with the item of position information. Furthermore, the item of traffic event information may be provided with a timestamp in the step of inputting or in the step of transmitting.

Furthermore, the present invention provides a device which has units for carrying out one of the above-mentioned methods.

Therefore, the present invention provides a device, which is designed to carry out or implement the steps of one of the above-mentioned methods. In particular, the device may have units which are designed to carry out the steps (for example, one per each unit) of one of the methods. The object on which the present invention is based may also be achieved rapidly and efficiently by this embodiment variant of the present invention in the form of a device.

A device may be understood in the present case as an electrical or electronic device, which is designed to determine a driving recommendation for a vehicle and/or to provide a driving recommendation for vehicles. The device may have an interface, which may be designed in hardware and/or software. In the case of a hardware design, the interfaces may be part of a so-called system ASIC, for example, which contains greatly varying functions of the device. However, it is also possible that the interfaces are separate integrated circuits or are made at least partially of discrete components. In the case of a software design, the interfaces may be software modules, which are provided on a microcontroller in addition to other software modules, for example.

A computer program product having program code is also advantageous, which is stored on a machine-readable medium, such as a semiconductor memory, a hard drive memory, or an optical memory and is used to carry out one of the above-mentioned methods when the program is executed on a device.

The present invention is based on the finding that reports with respect to traffic events, for example, congestion warnings, may be provided and/or propagated or received with the aid of Internet-capable navigation devices by incorporation of social media platforms. In particular, traffic-relevant content, which is provided by users of the social media platform thereon, in the form of the items of traffic event information may in turn be provided to users of the social media platform, to generate driving recommendations.

The advantages of the present invention are that precision, topicality, and validity of traffic reports may be improved by the driving recommendation based on the item of traffic event information. For example, the items of traffic event information may be available in real time or almost in real time. Therefore, a traffic event may be reacted to rapidly on the part of a vehicle driver on the basis of the driving recommendation. In conjunction with the driving recommendation, conventional traffic messages may be made more informative, for example, to make it easier to decide to take a detour proposed in a conventional way. Other types of items of instantaneous auxiliary information, for example, items of information about mobile radar traps or the like, which are only broadcast by a few radio stations via normal broadcast radio, for example, may also be obtained via the Internet platform.

In particular, in the step of receiving or in the step of inputting, the item of traffic event information may represent a traffic event from a predefined list of traffic events. Therefore, an unambiguous identifier may be associated with each of a number of predefined traffic events. The identifier may in turn be linked on the part of the navigation device to predetermined metrics, weightings, or the like, which may be analyzed or may be applied to the item of route information, to determine or provide the driving recommendation. In the case of the provision of the driving recommendation, the predefined list of traffic events may also be displayed or communicated to a user of the navigation device. The user input may therefore represent a selection action from the list. Therefore, in the step of inputting, the item of traffic event information may be generated automatically based on the selection from the list of traffic events. Then, in the step of transmitting, the item of traffic event information may be output in the form of an automatically generated message in a standardized format on the Internet platform. In the case of the determination of the driving recommendation, in the step of receiving, with the aid of suitable units of the navigation device, for example, reference tables or the like, the specific traffic event, and optionally associated influencing factors for determining the driving recommendation, may be identified and/or extracted based on the item of traffic event information. Such a specific embodiment offers the advantage that providing or determining the driving recommendation is greatly simplified by the use of the predefined list of traffic events. Only a selection action from the predefined list is sufficient on the part of a user for providing the driving recommendation. In the case of the determination of the driving recommendation, the standardization of the traffic events with the aid of the predefined list makes it easier to correctly identify the specific traffic event and therefore improves the precision of the driving recommendation.

According to one specific embodiment, the social media Internet platform having at least one user group, the navigation device being a subscriber unit of a member of at least one user group of the social media Internet platform, in the step of receiving, the item of traffic event information and the item of position information may be received with the aid of the navigation device by members of the at least one user group of the social media Internet platform or, in the step of transmitting, the item of traffic event information and the item of position information may be transmitted with the aid of the navigation device to members of the at least one user group of the social media Internet platform. The user group may be designed in the form of a closed user group within the social media Internet platform, for example. Users or members may have a user account, via which a user may identify himself as an actual member of the user group. The Internet-capable navigation device, which has a login function to the social media Internet platform, for example, may be logged in to the social media Internet platform during a route guidance procedure. The navigation device is therefore a subscriber unit of the user group. The user group may be a profile or (group) account within the social media Internet platform. Items of information may be sent from the user group to the subscribers or subscriber units of the user group. Subscribers or subscriber units of the user group may also send items of information to the user group. Therefore, items of information may be distributed within the user group. In particular, the user group may also be a specific fan page of an automobile manufacturer or the like. Such a specific embodiment offers the advantage that the driving recommendation may be provided or determined in an uncomplicated way. A distribution of the driving recommendation to a plurality of navigation devices or a determination of the driving recommendation from items of traffic event information from a plurality of navigation devices is therefore made easier.

According to one specific embodiment, the social media Internet platform having at least one user group, the navigation device being a subscriber unit of a member of the at least one user group of the social media Internet platform, at least one further navigation device of at least one further vehicle being a subscriber unit of a further member of the at least one user group of the social media Internet platform, in the step of receiving, at least one item of traffic event information and an item of position information, which is associated with the at least one item of traffic event information, which originates from the at least one further navigation device of the further member of the one user group, may be received with the aid of the navigation device from the member of the at least one user group of the social media Internet platform or, in the step of transmitting, the item of traffic event information and the item of position information may be transmitted with the aid of the navigation device to the further member of the at least one user group of the social media Internet platform, the item of traffic event information and the item of position information being receivable by the at least one further navigation device of the at least one user group. Such a specific embodiment offers the advantage that the driving recommendation may be provided or determined in an uncomplicated way. Distribution of the driving recommendation to a plurality of navigation devices or determination of the driving recommendation from items of traffic event information from a plurality of navigation devices is therefore made easier.

A step of checking the item of traffic event information and the item of position information for plausibility while using travel data of the vehicle, items of traffic information, or a number of identical or content-related items of traffic event information with items of position information which are identical within a tolerance range may also be provided. The navigation system may ascertain travel data, for example, items of position information, items of speed information, and/or items of travel direction information, from satellite signals or the like. An item of position information, an item of speed information, and/or an item of travel direction information may represent travel data in this case. The items of traffic information may include reports from conventional traffic reporting systems, for example, RDS, TMC, or the like. Multiple items of traffic event information may be received during the determination of the driving recommendation. A preferably extensive conformity with respect to location and time of preferably conformed traffic events which are represented by items of traffic event information may also allow a statement with respect to the plausibility. The step of checking may be carried out in the case of the provision of the driving recommendation prior to the step of transmitting or in the case of the determination of the driving recommendation prior to the step of analyzing. The item of traffic event information or the driving recommendation may also be associated with a plausibility value. Such a specific embodiment offers the advantage that an item of traffic event information or a driving recommendation may be subjected to a content check, so that the validity and the correctness of the item of traffic event information or the driving recommendation may be improved.

In addition, a step of discarding the item of traffic event information may be provided if, in the step of checking, no plausibility of the item of traffic event information and the item of position information are established. The step of discarding may be carried out in the case of the provision of the driving recommendation prior to the step of transmitting or in the case of determination of the driving recommendation prior to the step of analyzing. The step of transmitting or the step of analyzing may then be bypassed or suppressed. In particular, the step of discarding may therefore be carried out if in the step of checking a contradiction has resulted between the item of traffic event information and travel data, items of traffic information from other sources, or the multiple items of traffic event information, and therefore no plausibility has resulted. For example, at least one of the multiple items of traffic event information may represent a contradictory traffic event. Such a specific embodiment offers the advantage that providing or determining an incorrect, unintentional, or intentionally false driving recommendation or item of traffic event information may be effectively prevented.

Furthermore, in conjunction with determining the driving recommendation, a step of modifying an existing route, which was determined with the aid of the navigation device, based on the driving recommendation may be provided, to produce a modified route. A step of outputting the modified route to a user interface of the navigation device may also be provided. The modified route may include a detour, for example, which is recommended or traveled as a result of the driving recommendation. A route, via which the navigation device guides the driver of the vehicle to the destination, may therefore also be based on the driving recommendation. In the case of the step of outputting, the individual driving recommendation may be visually and/or acoustically output to the driver of the vehicle with the aid of the navigation device, for example, in the form of a route. Such a specific embodiment offers the advantage that the driving recommendation may be taken into consideration during route guidance with the aid of the navigation device. The route guidance may therefore be improved.

### BRIEF DESCRIPTION OF THE DRAWINGS

FIG. 1 shows a schematic block diagram of devices according to exemplary embodiments of the present invention as parts of a system for providing and determining driving recommendations.

FIG. 2 shows a flow chart of a method according to one exemplary embodiment of the present invention.

FIG. 3 shows a flow chart of another method according to one exemplary embodiment of the present invention.

### DETAILED DESCRIPTION

The figures of the drawings, the description thereof, and the claims contain numerous features in combination. It is clear to those skilled in the art that these features may also be considered individually or combined to form further combinations which are not explicitly described here. Furthermore, method steps according to the present invention may be carried out repeatedly and also in a sequence other than the sequence described. If an exemplary embodiment includes an “and/or” linkage between a first feature/step and a second feature/step, this may be read to mean that the exemplary embodiment according to one specific embodiment has both the first feature/the first step and the second feature/the second step and according to another specific embodiment has either only the first feature/the first step or only the second feature/the second step.

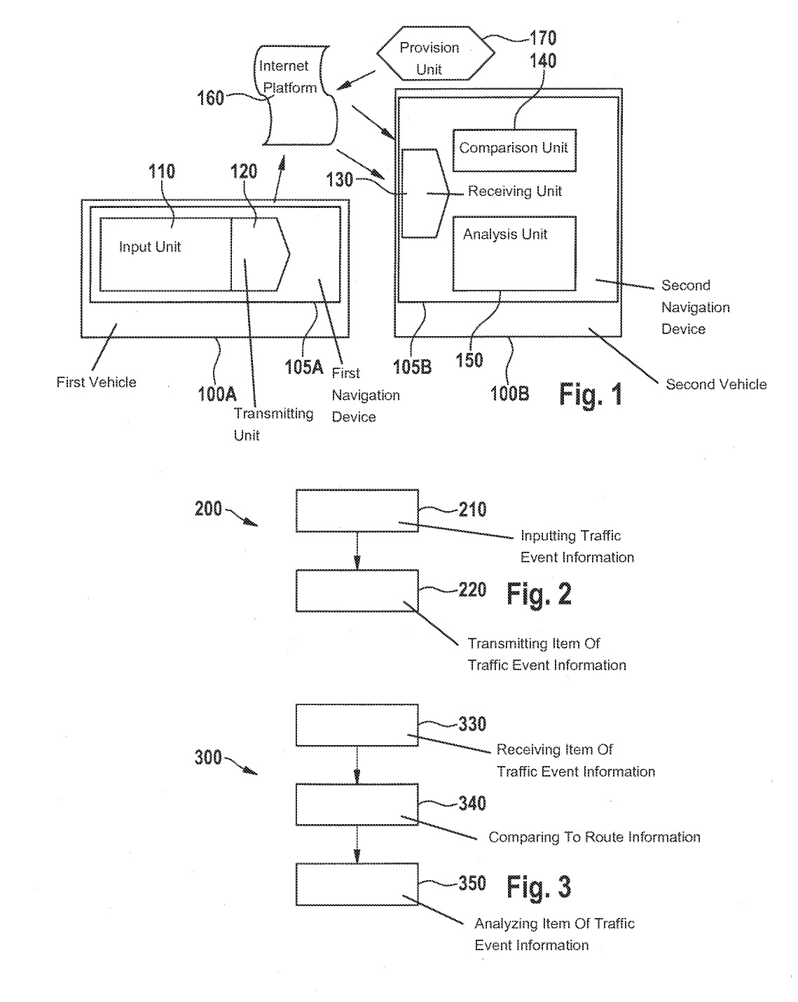

FIG. 1 shows a schematic block diagram of a device for determining a recommendation for a vehicle and a device for providing a driving recommendation for vehicles, according to exemplary embodiments of the present invention, as parts of a system for providing and determining driving recommendations. A first vehicle 100A, a second vehicle 100B, a first navigation device 105A, a second navigation device 105B, an input unit 110, a transmitting unit 120, a receiving unit 130, a comparison unit 140, an analysis unit 150, a social media Internet platform 160, and a provision unit 170 for items of auxiliary information are shown. First vehicle 100A has first navigation device 105A having input unit 110 and transmitting unit 120. Second vehicle 100B has second navigation device 105B having receiving unit 130, comparison unit 140, and analysis unit 150.

Input unit 110 may be electrically connected to an input interface, which may be designed as a part of first navigation device 105A or as a component connected thereto with the aid of a communication interface. The input interface may have a keypad and/or a touch screen. Input unit 110 is designed to input an item of traffic event information based on a user input. The user input may be carried out with the aid of the communication interface. Input unit 110 may be electrically connected to transmitting unit 120 and may be designed to output the item of traffic event information to transmitting unit 120.

Transmitting unit 120 is designed to transmit the item of traffic event information and an item of position information, which is associated with the item of traffic event information and which represents a position of first vehicle 100A at a point in time of the input of the item of traffic event information, via a wireless data connection to social media Internet platform 160, to provide the driving recommendation. For this purpose, first navigation device 105A may have suitable a communication arrangement.

Input unit 110 or transmitting unit 120 may additionally be designed to generate the item of position information, and optionally a timestamp, and/or to associate them with the item of traffic event information. Alternatively, the item of position information may also be generated by a further unit of first navigation device 100A.

Social media Internet platform 160 is designed to receive the driving recommendation in the form of the item of traffic event information and the associated item of position information. Social media Internet platform 160 may in particular have a user group, which is generated within social media Internet platform 160. More precisely, transmitting unit 120 may be designed to transmit the driving recommendation to the user group. For this purpose, first navigation device 105A is logged in as a subscriber unit of the user group. Multiple terminals may be logged in as subscriber units on the user group of social media Internet platform 160. Social media Internet platform 160 is designed to cause a distribution of the driving recommendation to the subscriber units within the user group. Second navigation device 105B is a subscriber unit of the user group.

Receiving unit 130 may therefore be designed to receive the item of traffic event information and the associated item of position information from social media Internet platform 160. Second navigation device 105B may have a suitable communication arrangement for this purpose. The transmitting unit is designed to output at least the item of position information, which is associated with the item of traffic event information, to comparison unit 140.

Comparison unit 140 is designed to receive at least the item of position information which is associated with the item of traffic event information from receiving unit 130. Comparison unit 140 is also designed to compare the item of position information to an item of route information, which represents a route to be traveled by second vehicle 100B, in order to ascertain whether a position represented by the item of position information lies on the route to be traveled by second vehicle 100B. Comparison unit 140 may be designed, based on a result of the comparison, to generate an item of comparison information representing the result of the comparison and to output it to analysis unit 150.

to determine the driving recommendation based on the item of traffic event information if the position represented by the item of position information lies on a route to be traveled by second vehicle 100B. If the position represented by the item of position information does not lie on a route to be traveled by second vehicle 100B, analysis unit 150 may be designed to discard the item of traffic event information.

Provision unit 170 may be optional in the system shown in FIG. 1. Provision unit 170 may be a profile, portal, or the like on social media Internet platform 160. Provision unit 170 may also be associated with the user group. Provision unit 170 may be designed to output items of auxiliary information to social media Internet platform 160, and in particular to the user group. Social media Internet platform 160 is designed to cause a distribution of the items of auxiliary information to the subscriber units within the user group. Receiving unit 130 may therefore also be designed to receive the items of auxiliary information from social media Internet platform 160 or provision unit 170.

In other words and stated in summary, according to the exemplary embodiment shown in FIG. 1, first navigation device 105A is a device which sends the driving recommendation. Input unit 110 and transmitting unit 120 generate a message or email having the driving recommendation at the behest of the user and the driving recommendation is sent as an automated message, for example, via social media Internet platform 160, for example, Facebook, via a user account, for example, a Facebook account, of the user. During the input of the traffic event, for example, a key or a key combination may be pressed by the user on first navigation device 105A. Purely as an example, a key 1 may be pressed for slowly moving traffic, a key 2 for stop-and-go traffic, a key 3 for a traffic jam, a key 4 for a blockage, and a key 5 for a mobile radar trap. The instantaneous item of position information or item of location information of first vehicle 100A is automatically generated. On the part of social media Internet platform 160, a mail relay is carried out to a defined user group, for example, a fan group of a specific automobile brand. Provision unit 170 may provide items of auxiliary information, for example, event information by the operator of the user group. The units of second navigation device 105B as a receiver device filter the item of position information and optionally the items of auxiliary information. If the receiver device, i.e., second navigation 105B, is located, or if a route of second vehicle 100B extends outside a destination region ascertained based on the item of position information, second navigation device 105B may leave the message having the travel information unconsidered. Otherwise, an output and/or evaluation of the warning message or driving recommendation is carried out.

In other words, for example, Internet-capable navigation devices 105A of a user group or fan group may therefore function as a producer and sender of the driving recommendation and, for example, standardized congestion reports, reports about mobile radar traps, or other target-group-relevant events may be sent via the social media applications with automatic addition of the particular item of location information to the defined user group by active action of the user. A report of the traffic event may be provided in each case with the location at the point in time of input. Navigation devices 105B as receiving subscriber units of the users within the user group receive the report having the driving recommendation. The report may then be provided with an item of position information in conjunction with the appended location report or analyzed and a warning message may be output if the driving recommendation relates to the route or the location region of the receiver.

Although it is not explicitly shown in FIG. 1, first navigation device 105A may also have a receiving unit, a comparison unit, and an analysis unit, and second navigation 105B may also have an input unit and a transmitting unit. Therefore, first navigation device 105A and second navigation device 105B may have the same units. This is not shown in the drawing in FIG. 1 for reasons of simplification. Therefore, it is also to be clear that both first navigation device 105A and second navigation device 105B may have units which are designed for providing and determining a driving recommendation.

FIG. 2 shows a flow chart of a method 200 for providing a driving recommendation for a vehicle, according to one exemplary embodiment of the present invention. Method 200 is carried out while using a social media Internet platform and an Internet-capable navigation device, which is situated in a vehicle and is wirelessly connected to the social media Internet platform. The navigation device may be the first navigation device from FIG. 1, for example. Method 200 has a step of inputting 210 an item of traffic event information based on a user input with the aid of the navigation device. Method 200 also has a step of transmitting 220 the item of traffic event information and an item of position information, which is associated with the item of traffic event information, and which represents a position of the vehicle at a point in time of input (210) of the item of traffic event information, with the aid of the navigation device to the social media Internet platform, to provide the driving recommendation.

FIG. 3 shows a flow chart of a method 300 for determining a driving recommendation for a vehicle, according to one exemplary embodiment of the present invention. Method 300 is carried out while using a social media Internet platform and an Internet-capable navigation device, which is situated in the vehicle and is wirelessly connected to the social media Internet platform. The navigation device may be the second navigation device from FIG. 1, for example. Method 300 has a step of receiving 330 an item of traffic event information and an item of position information, which is associated with the item of traffic event information, from the social media Internet platform with the aid of the navigation device. Method 300 also has a step of comparing 340 the item of position information to an item of route information, which represents a route to be traveled by the vehicle, with the aid of the navigation device, to ascertain whether a position represented by the item of position information lies on the route to be traveled by the vehicle. Furthermore, method 300 has a step of analyzing 350 the item of traffic event information if the position represented by the item of position information lies on a route to be traveled by the vehicle, to determine the driving recommendation for the vehicle based on the item of traffic event information.

1.-10. (canceled)

11. A method for determining a driving recommendation for a vehicle, the method being carried out while using a social media Internet platform and an Internet-capable navigation device, which is situated in the vehicle and is wirelessly connected to the social media Internet platform, the method comprising:
receiving an item of traffic event information and an item of position information, which is associated with the item of traffic event information, from the social media Internet platform with the aid of the navigation device;
comparing the item of position information to an item of route information, which represents a route to be traveled by the vehicle with the aid of the navigation device, to ascertain whether a position represented by the item of position information lies on a route to be traveled by the vehicle; and
analyzing the item of traffic event information if the position represented by the item of position information lies on the route to be traveled by the vehicle, to determine the driving recommendation for the vehicle based on the item of traffic event information.

12. The method as recited in claim 11, wherein, in the step of receiving, the item of traffic event information represents a traffic event from a predefined list of traffic events.

13. The method as recited in claim 11, wherein:
the social media Internet platform includes at least one user group,
the navigation device includes a subscriber unit of a member of the at least one user group of the social media Internet platform,
in the step of receiving, the item of traffic event information and the item of position information are received with the aid of the navigation device from the at least one user group of the social media Internet platform.

14. The method as recited in claim 11, wherein:
the social media Internet platform includes at least one user group,
the navigation device includes a subscriber unit of a member of the at least one user group of the social media Internet platform,
at least one further navigation device of at least one further vehicle being a subscriber unit of a member of the at least one user group of the social media Internet platform,
in the step of receiving, at least one item of traffic event information and an item of position information, which is associated with the at least one item of traffic event information, which originate from the at least one further navigation device of the member of the at least one user group, are received with the aid of the navigation device from the at least one user group of the social media Internet platform.

15. The method as recited in claim 11, further comprising:
checking the item of traffic event information and the item of position information for plausibility while using travel data of the vehicle, wherein one of items of traffic information and one of a number of identical items and content-related items of traffic event information having identical items of position information within a tolerance range.

16. The method as recited in claim 15, further comprising:
discarding the item of traffic event information if, in the step of checking, no plausibility of the item of traffic event information and the item of position information are established.

17. The method as recited in claim 11, further comprising:
modifying an existing route, which is determined with the aid of the navigation device, based on the driving recommendation, to generate a modified route; and
outputting the modified route to a user interface of the navigation device.

18. A method for providing a driving recommendation for a vehicle, the method being carried out while using a social media Internet platform and an Internet-capable navigation device, which is situated in a vehicle and is wirelessly connected to the social media Internet platform, the method comprising:
inputting an item of traffic event information based on a user input into the navigation device; and
transmitting the item of traffic event information and an item of position information, which is associated with the item of traffic event information and represents a position of the vehicle at a point in time of the input of the item of traffic event information, with the aid of the navigation device to the social media Internet platform, to provide the driving recommendation.

19. The method as recited in claim 18, wherein, in the step of inputting, the item of traffic event information represents a traffic event from a predefined list of traffic events.

20. The method as recited in claim 18, wherein:
the social media Internet platform includes at least one user group,
the navigation device includes a subscriber unit of a member of the at least one user group of the social media Internet platform,
in the step of transmitting, the item of traffic event information and the item of position information are transmitted with the aid of the navigation device to at least further members of the at least one user group of the social media Internet platform.

21. The method as recited in claim 18, wherein:
the social media Internet platform includes at least one user group,
the navigation device includes a subscriber unit of a member of the at least one user group of the social media Internet platform, at least one further navigation device of at least one further vehicle being a subscriber unit of a member of the at least one user group of the social media Internet platform,
wherein, in the step of transmitting, the item of traffic event information and the item of position information are transmitted with the aid of the navigation device to at least further members of the at least one user group of the social media Internet platform, the item of traffic event information and the item of position information being receivable for the at least one further navigation device of the at least one user group.

22. The method as recited in claim 18, further comprising:
checking the item of traffic event information and the item of position information for plausibility while using travel data of the vehicle, wherein one of items of traffic information and one of a number of identical items and content-related items of traffic event information having identical items of position information within a tolerance range.

23. The method as recited in claim 18, further comprising:
discarding the item of traffic event information if, in the step of checking, no plausibility of the item of traffic event information and the item of position information are established.

24. The method as recited in claim 18, further comprising:
modifying an existing route, which is determined with the aid of the navigation device, based on the driving recommendation, to generate a modified route; and
outputting the modified route to a user interface of the navigation device.

25. A device for determining a driving recommendation for a vehicle, the device being used while using a social media Internet platform and an Internet-capable navigation device, which is situated in the vehicle and is wirelessly connected to the social media Internet platform, the device comprising:
an arrangement for receiving an item of traffic event information and an item of position information, which is associated with the item of traffic event information, from the social media Internet platform with the aid of the navigation device;
an arrangement for comparing the item of position information to an item of route information, which represents a route to be traveled by the vehicle with the aid of the navigation device, to ascertain whether a position represented by the item of position information lies on a route to be traveled by the vehicle; and
an arrangement for analyzing the item of traffic event information if the position represented by the item of position information lies on the route to be traveled by the vehicle, to determine the driving recommendation for the vehicle based on the item of traffic event information.

26. A device for providing a driving recommendation for a vehicle, the device being used while using a social media Internet platform and an Internet-capable navigation device, which is situated in a vehicle and is wirelessly connected to the social media Internet platform, the device comprising:
an arrangement for inputting an item of traffic event information based on a user input into the navigation device; and
an arrangement for transmitting the item of traffic event information and an item of position information, which is associated with the item of traffic event information and represents a position of the vehicle at a point in time of the input of the item of traffic event information, with the aid of the navigation device to the social media Internet platform, to provide the driving recommendation.

27. A computer program product having program code which is stored on a machine-readable medium for carrying out a method for determining a driving recommendation for a vehicle, the method being carried out while using a social media Internet platform and an Internet-capable navigation device, which is situated in the vehicle and is wirelessly connected to the social media Internet platform, the method comprising:
receiving an item of traffic event information and an item of position information, which is associated with the item of traffic event information, from the social media Internet platform with the aid of the navigation device;
comparing the item of position information to an item of route information, which represents a route to be traveled by the vehicle with the aid of the navigation device, to ascertain whether a position represented by the item of position information lies on a route to be traveled by the vehicle; and
analyzing the item of traffic event information if the position represented by the item of position information lies on the route to be traveled by the vehicle, to determine the driving recommendation for the vehicle based on the item of traffic event information.

28. A computer program product having program code which is stored on a machine-readable medium for carrying out a method for providing a driving recommendation for a vehicle, the method being carried out while using a social media Internet platform and an Internet-capable navigation device, which is situated in a vehicle and is wirelessly connected to the social media Internet platform, the method comprising:
inputting an item of traffic event information based on a user input into the navigation device; and
transmitting the item of traffic event information and an item of position information, which is associated with the item of traffic event information and represents a position of the vehicle at a point in time of the input of the item of traffic event information, with the aid of the navigation device to the social media Internet platform, to provide the driving recommendation.
